(19) United States
(12) Patent Application Publication
(10) Pub. No.: US 2026/0337913 A1
(43) Pub. Date: Oct. 29, 2026

(54) DEVICE PROTECTION COVER-FUSED POLYMER SMART MANHOLE COVER EMPLOYING DIRECT TRANSMISSION METHOD, AND SMART MONITORING MANAGEMENT SYSTEM USING SAME

(71) Applicant: Yoon Ho CHOI, Daegu (KR)

(72) Inventor: Yoon Ho CHOI, Daegu (KR)

(21) Appl. No.: 19/123,362

(22) PCT Filed: Nov. 3, 2022
(86) PCT No.: PCT/KR2022/017180

§ 371 Date: Apr. 22, 2025

(30) Foreign Application Priority Data
Oct. 24, 2022 (KR) 10-2022-0137437

(51) Int. Cl. E02D 29/14; G01F 23/296

(52) U.S. Cl. CPC E02D 29/1472; G01F 23/296

(57) ABSTRACT

The present invention relates to a manhole cover including a polymer composite material that transmits radio waves, and is characterized and advantageous in that the manhole cover employs a direct transmission method unlike an indirect transmission method of a conventional cast manhole, measures a water level and a toxic gas by using a device structure installed into a device protection cover structure (530), and has a manhole cover fusion surface (512) and a protection cover fusion surface (532) fused to each other when fusing the device protective cover structure (530) to a manhole cover lower surface part (520), in which \textcircled{1} a maximum fusion force (M) is generated by maximizing a fusion area between the two surfaces, \textcircled{2} an anchor force (A) is generated by a fusion inclination angle (α) of an inclined fastening part (531a) to be inserted into an inclined edge fastening groove (514), and \textcircled{3} a combined resultant force (T) of the maximum fusion force (M) and the anchor force (A) of the fusion inclination angle (α) corresponds to a maximum resistance support force against a rotating wheel friction force and a vehicle speed impact load of a large passing vehicle.

### TECHNICAL FIELD

The disclosure relates to a device protection cover-fused polymer smart manhole cover employing a direct transmission method, and a smart monitoring management system using the same, and more specifically, to a device protection cover-fused polymer smart manhole cover employing a direct transmission method, which is advantageously characterized in that: the manhole cover includes a polymer composite material that transmits radio waves, and employs a direct transmission method unlike a related cast manhole that employs an indirect transmission method; a water level and a toxic gas are measured by using a device structure installed into a device protection cover structure (530); and fusing the device protection cover structure (530) to a manhole cover bottom surface portion (520) involves fusing a manhole cover fusion surface (512) and a protection cover fusion surface (532) to each other, in which \textcircled{1} a maximum fusion force (M) is generated by maximizing a fusion area between the two surfaces, \textcircled{2} an anchor force (A) is generated by a fusion inclination angle (α) of an inclined fastening part (531a) for insertion into an inclined edge fastening groove (514), \textcircled{3} a combined resultant force (T) of the maximum fusion force (M) and the anchor force (A) of the fusion inclination angle (α) provides a maximum resistance support force against a rotating wheel friction force and a vehicle speed impact load of a large passing vehicle, \textcircled{4} the protection cover fusion surface (532), cured and at room temperature, is pressure-fused with the manhole cover fusion surface (512), which is in a molten state and at 200 to 230 °C, with a fusion depth t=5 to 10 mm, a fusion inclination angle α=2 to 5°, and an insertion tolerance Δ=1.0 to 2.5 mm, thereby allowing the freshly molded molten manhole cover to be strongly fused with the protection cover fusion surface (532) through cooling shrinkage, and, \textcircled{5} a fixing bolt head part (534a) is positioned between the manhole cover fusion surface (512) and the protection cover fusion surface (532), thereby greatly increasing the fixing force of a fixing bolt body part (534), which is an extension of the fixing bolt head part (534a), and a smart monitoring management system using the same.

### BACKGROUND

A manhole is an inspection port provided to allow inspection of a substance passing inside.

The passing substance may be mainly sewage, water supply, city gas, etc. There is a confined space inside the manhole. Harmful gases such as CO, H₂S, CH₄, NH₃ may accumulate in the space.

The harmful gases are usually generated due to hazardous substances entrained and flowing through sewage pipes connected to the manhole, or foreign substances introduced into the manhole.

In addition, heavy rain or sudden torrential downpour can cause a rapid rise in the water level inside the manhole, resulting in the manhole cover opening or even being displaced from its original position and lost. The manhole cover in open state poses the risk of overturning vehicles and causing fatal personal injuries due to fall accidents.

Heavy rains or sudden torrential rains cause enormous property damage in low-lying flooded areas, including underground parking lots.

In the confined space inside the manhole, harmful gases may be generated and accumulate, which can be life-threatening to the inspector.

As such, there is a need for a 24-hour monitoring management system to prevent the fatal risk of personal injury caused by vehicle overturning and fall accidents resulting from manhole covers opening due to rapid rises in water level during heavy rains, and also to prevent the fatal life-threatening risks to inspectors caused by the accumulation of harmful gases in the enclosed space inside the manhole.

The monitoring management system is a system in which a water level measurement value and a harmful gas concentration measurement value inside the manhole are transmitted in real time basis, and a remote central control room on the ground receiving the measurement values performs monitoring and management based on the received data. At this time, the measurement values are transmitted from the inside of the manhole through the manhole cover.

All manholes currently in use are cast iron manholes.

Generally, the structure of the manhole includes a manhole housing buried beneath the road and a manhole cover that opens and closes on top of it. Large vehicles pass over the manhole cover at high speed. The support strength of the manhole cover is the strength of material against “heavy vehicle load”, “vehicle speed impact load” and “rotating wheel friction force”.

The cast iron manhole includes materials with sufficient strength of material.

However, the biggest problem with the casting manholes is that, due to their material properties, the casting manholes do not allow radio waves to pass through.

Generally, the water level and harmful gas concentration inside the manhole are measured and then the measurements are transmitted through the manhole cover to the central control room on the ground.

However, cast iron is a material that does not allow radio waves to pass through. In order for radio waves to pass through the cast iron cover that is impermeable to radio waves, a radio wave through-hole should be formed in the cast iron cover. For this reason, all related cast iron manhole covers have a radio wave through-hole in the center. The radio wave through-hole is a passage that allows the inner and outer spaces of the manhole cover to communicate as one, and it is a radio wave propagation space. An antenna for radio wave transmission is installed in the radio wave propagation space. The antenna for radio wave transmission is a communication medium that connects the inside and outside of the manhole.

Without a radio wave through-hole in the cast iron manhole cover, radio wave transmission through the manhole cover is impossible. As such, if transmission can occur only through the transmitting antenna of the radio wave through-hole of the cast iron manhole cover, it is considered an “indirect transmission method”, and conversely, if transmission of radio wave occurs through the manhole cover without a radio wave through-hole or transmitting antenna, it is relatively considered a “direct transmission method.”

The “indirect transmission method” of the cast iron manhole cover is characterized by the radio wave through-hole, the transmitting antenna, and the exposure of its surface layer. The surface layer of the cast iron manhole cover is the part that the wheels of a large vehicle directly contact. In addition, the surface layer is the part where the radio wave through-hole, with the transmitting antenna assembled thereto, is exposed.

Hereinbelow, the problems with the characteristics of the “indirect transmission method” will be discussed.

First, the “rotating wheel friction force” of a large vehicle repeatedly and strongly contacts the antenna exposed on the surface of the cast iron manhole cover, causing the antenna to be dislodged or destroyed from its place. In addition, the “vehicle speed impact load” is repeatedly added, causing strong impacts and vibrations to be repeatedly applied to the assembly structure of the antenna, loosening the assembly and further aggravating the dislodgement of the antenna, resulting in loss of antenna function.

Second, the vibration and impact from the “rotating wheel friction force” and the “vehicle speed impact load” are repeatedly applied to the antenna assembly structure, loosening the assembly and generating a gap between the antenna and the assembly part or between the antenna and the radio wave through-hole. Even if this does not lead to the antenna dislodging, the gap allows the rainwater to enter, causing corrosion of moisture-sensitive components such as printed circuit boards (PCBs), batteries (128), modem devices, and malfunction and loss of function.

Third, unlike the “direct transmission method”, the “indirect transmission method” employs the transmitting antenna which is in an assembly exposed on the surface of the radio wave through-hole of the cast iron manhole cover, thus requiring not only a “waterproof structure” against rainwater, but also a separate antenna assembly structure to handle vibration and impact from the “rotating wheel friction force” and the “vehicle speed impact load” of a large vehicle that are repeatedly applied to the antenna on the surface of the cast iron manhole cover. In addition, the separate assembly structure also requires additional structures such as an antenna dislodgement prevention structure and a disassembly prevention structure to maintain its durability, which makes the antenna and its associated structures more complex, inefficient and uneconomical.

Hereinbelow, from the above viewpoints, problems associated with the “indirect transmission method” will be discussed with reference to specific examples of related arts.

### 1) Related Art 1: Korean Patent Publication No. 10-2022-0103283 (ICT-Based Manhole Cover Assembly and ICT-Based Sewage Management System Including the Same)

Related Art 1 is shown in FIGS. 1, 2, 3, and 4.

The manhole of Related Art 1 is a cast iron manhole.

According to this, the measurement values from the water level detection sensor (124) and the gas sensor (125) of the sensor module (120) are transmitted to the remote central control room on the ground by the transmitting antenna (126) assembled in the through hole (113) of the cast iron manhole cover (110). This is for monitoring purposes. In this example, since the transmitting antenna assembled in the radio wave propagation space (e.g., through hole (113)) is a communication medium connecting the inside and outside of the manhole, it is the “indirect transmission method” of the cast iron manhole.

The transmitting antenna (126) assembled in the through hole (113) of the cast iron manhole cover (110) is an assembly structure simply surrounded by a sealing member (114). Because the exposed assembly structure is highly vulnerable to repeated contact, vibration, and impact from the “rotating wheel friction force” and the “vehicle speed impact load” of the large vehicle, the transmitting antenna (126) is easily dislodged or gaps are inevitably formed in the assembly, and accordingly, the three problems of the “indirect transmission method” described above with reference to the cast iron manhole of Related Art 1 occur due to the same causes. Accordingly, the three problems of Related Art 1 will be incorporated by reference as discussed above.

Meanwhile, since Related Art 1 employs the “indirect transmission method” and the assembled structure of the transmitting antenna (126), there is a problem in that the repeated contact, vibration, and impact from the “rotating wheel friction force” and the “vehicle speed impact load” of the large vehicle can cause the transmitting antenna (126) to become dislodged or create a gap through which rainwater can enter, resulting in corrosion and malfunction of moisture-sensitive components such as the printed circuit board and battery (128) of the sensor module (120).

Measuring the water level change and harmful gas concentration inside the manhole in Related Art 1 is performed by the water level detection sensor (124) and gas sensor (125) on the bottom surface portion of the cast iron manhole cover (110) as shown in FIG. 1. FIG. 4 is a block diagram showing the control relationship of the main components of the sewage management system of Related Art 1.

### 2) Related Art 2: Korean Patent Registration No. 10-2001960 (Antenna Module Waterproof and Embedded Structure of Smart Manhole Cover)

Related Art 2 is shown in FIGS. 5 and 6.

The manhole of Related Art 2 is a cast iron manhole.

According to Related Art 2, a structure is provided, in which the antenna (51) is assembled in the through hole (15c) in the center of the cast iron manhole cover (10). Since the antenna (51) assembled in the radio wave propagation space [through hole (15c)] is a communication medium connecting the inside and outside of the manhole, it is the “indirect transmission method” of the cast iron manhole.

The antenna module (50) is a module in which the antenna (51) is positioned between the lower cover (52) and the upper cover (53) as shown in FIG. 6. The modem device (60) is positioned at the bottom of the cast iron manhole cover (10), that is, below the antenna module (50).

As shown in FIG. 6, the antenna module (50) of Related Art 2 is an assembled structure of an antenna (51), a lower cover (52), and an upper cover (53), which is exposed on the surface layer of the cast iron manhole cover (10), and therefore, the structure is vulnerable to repeated contact, vibration, and impact from the “rotating wheel friction force” and the “vehicle speed impact load” of the large vehicle and the antenna (51) is easily dislodged or gaps are inevitably formed in the assembled structure. Therefore, the cast iron manhole of Related Art 2 also suffers the three problems of the “indirect transmission method” described above for the same causes. Accordingly, the three problems of Related Art 2 will be incorporated by reference as discussed above.

Meanwhile, since the structure in Related Art 2 employs the assembled structure in which the antenna (51) is assembled with the lower cover (52) and the upper cover (53) for the “indirect transmission method”, there is a problem in that the repeated contact, vibration, and impact from the “rotating wheel friction force” and the “vehicle speed impact load” of the large vehicle can cause the antenna (51) to become dislodged or create a gap through which rainwater can enter, resulting in corrosion and malfunction of the moisture-sensitive components such as the printed circuit board and battery (128) of the sensor module (120).

The measurement inside the manhole of Related Art 2 is performed by the modem device (60) of FIG. 6. The control relationship of the main components of the measurement system of Related Art 2 is similar to the block diagram of FIG. 4.

As mentioned above, Related Arts 1 and 2 have the same problems as those described above with respect to the “indirect transmission method” of the cast iron manhole cover.

### DETAILED DESCRIPTION OF INVENTION

### Technical Problem

(a) An object of the disclosure is to provide a polymer smart manhole cover employing a “direct transmission method” in which, unlike the related indirect transmission method that transmits the radio waves via the transmitting antenna assembled in the radio wave through-hole of the cast iron manhole cover, the polymer smart manhole cover allows radio waves to pass through, thus eliminating a need for the radio wave through-hole of the transmitting antenna as a communication medium connecting inside and outside the manhole, and also eliminating a need for the assembly structure of the transmitting antenna assembled in the radio wave through-hole.

(b) Another object of the disclosure is to manufacture a polymer smart manhole cover that transmits radio waves in which, unlike the related indirect transmission method, the structure employing the direct transmission method does not suffer the problem of the indirect transmission method where the exposed antenna is dislodged or gaps are formed in the assembly due to vibration and impact resulting from the rotating wheel friction force and the vehicle speed impact load of a large vehicle, thereby preventing ingress of rainwater into the device protection cover structure and avoiding the problem of malfunction of the device structure housed therein, thereby improving the performance and durability of the device structure.

(c) The manhole cover is not only subjected to the repeated rotating wheel friction force and vehicle speed impact load of the large vehicle, but also serves as a location where the manhole cover and the device protection cover structure are coupled to each other, and in consideration of the above, yet another object of the disclosure is to adopt a fusion method to couple the two members instead of using the traditional bolt assembly method, and generate a maximum fusion force (M) by maximizing a fusion area between the two members, such that the vertical vibration resulting from the rotating wheel friction force and the vehicle speed impact load of the passing vehicle over the manhole cover is fully resisted by the maximum welding force (M), and at the same time, upper and lower device cases (550) of a device structure (540) installed in the space (S) are firmly fastened and fixed by a fixing bolt body part (534a), which is an extension of a fixing bolt head part (534a) disposed between the two members fused and prevented from separating and dislodging, a cover part (556) of the upper device case (550) is brought into close contact with a protection cover bottom surface portion (535), thereby minimizing a gap between the upper and lower device cases (550) against a strong vertical vibration of the manhole cover, a protection cover bottom plate (537), which is assembled with an ultrasonic water level sensor (548), is assembled to a cylindrical vertical support portion (536) by a connecting bolt (536b), thereby facilitating repair and battery replacement of the device structure (540), the maximum fusion force (M) is generated by the maximum fusion area of the protection cover fusion surface (532), and an anchor force (C) is generated by fusion inclination angles (α) of an inclined edge fastening groove (514) and a corresponding inclined fastening part (532a) for insertion into the inclined edge fastening groove (514), in which the two forces (M and C) are generated simultaneously such that a combined resultant force (T) of the two forces (M and C) provides a maximum resistance support force against the rotating wheel friction force and the vehicle speed impact load of the large vehicle, and in a state stabilized by this maximum resistance support force, measurements are obtained by using the ultrasonic water level sensor (548) and a gas sensor device (546) of the device structure (540) such that high-reliability measurement values are obtained and transmitted from a main device (544) through the polymer manhole cover to the central control room on the ground.

(d) Yet another object is to provide a plurality of condensation water drainage holes and odor detection inlets (5374c), which include clustered holes of 0.5 to 1.5 mm in diameter, formed at multiple locations on a horizontal part (5374), which is a lowermost surface of the device protection cover structure (530), so that the condensation water drainage holes and odor detection inlets (5374c) serve as an outlet for condensation generated due to the temperature difference between the inside and outside of the space (S), and also as an inflow path for the odor of toxic gas generated at the bottom of the manhole to the gas sensor device (546).

### Technical Solution

The configuration of a device protection cover structure-fused polymer smart manhole cover employing a direct transmission method according to the present disclosure is described below.

The device protection cover structure-fused polymer smart manhole cover employing the direct transmission method is characterized in that: the manhole cover employing the direct transmission method is a polymer composite material that transmits radio waves; integrally fusing the device protection cover structure (530) to the polymer smart manhole cover (500) involves pressure-fusing a protection cover fusion surface (532) of the device protection cover structure (530) to a manhole cover fusion surface (512) of a manhole cover bottom surface portion (520), in which: the polymer manhole cover is the manhole cover fusion surface (512) that is freshly molded and in a molten state at 200 to 230 °C, and the corresponding device protection cover structure (530) fused with the manhole cover fusion surface (512) is the protection cover fusion surface (532) that is already cured and at room temperature; the manhole cover bottom surface portion (520) includes the inclined edge fastening groove (514) having a fusion depth t=5 to 10 mm and a fusion inclination angle α=2 to 5°, and the protection cover fusion surface (532) includes the corresponding inclined fastening part (532a) for insertion into the inclined edge fastening groove (514), which has the same fusion depth and fusion inclination angle as those of the inclined edge fastening groove (514); an insertion tolerance between the inclined edge fastening groove (514) and the inclined fastening part (532a) is Δ=1.0 to 2.5 mm; a fixing bolt head part (534a) is disposed between the manhole cover fusion surface (512) and the protection cover fusion surface (532) and fusion-fixed; in a space (S) defined by a cylindrical vertical support portion (536) extending vertically from the protection cover fusion surface (532) and by the protection cover fusion surface (532), a device case (550) of a device structure, which is of a quadrangular box shape (552), is fixed by a fixing bolt body part (534) that is an extension of the fixing bolt head part (534a) disposed between the protection cover fusion surface (532) and the manhole cover fusion surface (512); and an ultrasonic water level sensor (548) is assembled and fixed to a protection cover bottom plate (537) with a helical fastening part (548a) thereof.

In addition, the device protection cover structure-fused polymer smart manhole cover employing the direct transmission method is characterized in that a maximum fusion force (M) is generated by a maximum fusion arca between the manhole cover fusion surface (512) and the protection cover fusion surface (532), and an anchor force (C) is generated by the fusion inclination angles (α) of the inclined edge fastening groove (514) and the corresponding inclined fastening part (532a) for insertion into the inclined edge fastening groove (514), in which the two forces (M and C) are generated simultaneously to provide a maximum resistance support force against a “rotating wheel friction force” and a “vehicle speed impact load” of a large vehicle.

Moreover, the device protection cover structure-fused polymer smart manhole cover employing the direct transmission method is characterized in that fixing the device structure (540) involves fixing device cases (550), which are of the same size and are arranged symmetrically on upper and lower sides as well as on both sides, within the space (S) by the fixing bolt body part (534) that is the extension of the fixing bolt head part (534a) disposed between the protection cover fusion surface (532) and the manhole cover fusion surface (512), and bringing a cover part (556) of the upper device case (550) into close contact with a protection cover bottom surface portion (535), thereby preventing the formation of a gap due to an impact vibration resulting from the “rotating wheel friction force” and the “vehicle speed impact load” of a large vehicle passing over the polymer smart manhole cover (500).

In addition, the device protection cover structure-fused polymer smart manhole cover employing the direct transmission method is characterized in that the device case (550), which is of the quadrangular box-shape (552) and is fixed and supported by the fixing bolt body part (534) that is the extension of the fixing bolt head part (534a) disposed between the protection cover fusion surface (532) and the manhole cover fusion surface (512), includes cases for a main device (542), a gas sensor device (544), and a battery pack (546) of the device structure (540), and the ultrasonic water level sensor (548) of the device structure (540) assembled to a fastening part (5374a) of the protection cover bottom plate (537) is fixed by a fixing nut (548b).

In addition, the device protection cover structure-fused polymer smart manhole cover employing the direct transmission method is characterized in that a plurality of condensation water drainage holes and odor detection inlets (5374c), which include clustered holes of 0.5 to 1 mm in diameter, are formed at multiple locations on a horizontal part (5374), which is a lowermost surface of the device protection cover structure (530).

The technical characteristics according to the configuration of the device protection cover structure-fused polymer smart manhole cover employing the direct transmission method according to the disclosure are described below.

1) The related cast iron manhole cover employs the indirect transmission method that uses the transmitting antenna assembled in the radio wave through-hole, whereas the polymer smart manhole cover according to the present disclosure employs the “direct transmission method” where the radio wave is allowed to pass through and thus the radio wave through-hole is not necessary. Accordingly, the present disclosure and the related art employ completely different transmission methods from each other, use the manhole covers of completely different shapes and structures from each other, and have completely different structural efficiencies (simple/complex) of the subsequent transmission installation structures related to transmission.

2) While the related art employing the indirect transmission method adopts an assembly structure that is exposed due to the radio wave through-hole of the transmitting antenna serving as a communication medium connecting the inside and outside of the manhole, the “direct transmission method” of the present disclosure allows transmission without requiring exposure. Therefore, the present disclosure prevents the issues such as dislodgement of the communication antenna and formation of the gap in the assembly, subsequent ingress of rainwater and malfunction of the device structure.

3) While the related art employing the indirect transmission method adopts a bolt assembly method with an exposed assembly structure, the “direct transmission method” of the present disclosure adopts a “fusion method” by melting.

The manhole cover fusion surface (512) and the protection cover fusion surface (532) are subject to the “fusion method.”

According to the present disclosure, the “fusion method” has the following characteristics: First, it generates the maximum fusion force (M) by maximizing the fusion area. Second, the anchor force (C) is generated by the fusion inclination angles (α) of the inclined edge fastening groove (514) and the corresponding inclined fastening part (532a) inserted into the inclined edge fastening groove (514). Third, the combined resultant force (T) of the maximum fusion force (M) and the anchor force (C) of the fusion inclination angles (α) provides the maximum resistance support force against the rotating wheel friction force and the vehicle speed impact load of the large passing vehicle. Fourth, the protection cover fusion surface (532), cured and at room temperature, is pressure-fused with the manhole cover fusion surface (512), which is in a molten state and at 200 to 230 °C, with the fusion depth t=5 to 10 mm, the fusion inclination angle α=2 to 5°, and the insertion tolerance Δ=1.0 to 1.5 mm, thereby allowing the freshly molded molten manhole cover to be strongly fused with the protection cover fusion surface (532) through cooling shrinkage. Fifth, by positioning the fixing bolt head part (534a) between the manhole cover fusion surface (512) and the protection cover fusion surface (532), the fixing force of the fixing bolt body part (534), which is an extension of the fixing bolt head part (534a), is greatly increased.

4) Meanwhile, in a stable state where the combined resultant force (T) of the maximum fusion force (M) and the anchor force (C) from the fusion inclination angle (α) provides the maximum resistance support force against the rotating wheel friction force and the vehicle speed impact load of a large passing vehicle, measurements can be obtained using the ultrasonic water level sensor (548) and the gas sensor device (546) of the device structure (540), and accordingly, highly reliable measurement values can be obtained and also transmitted through the polymer manhole cover from the main device (544).

5) The fixing bolt head part (534a) is positioned between the manhole cover fusion surface (512) and the protection cover fusion surface (532), and while the fixing force of the fixing bolt body part (534), which is an extension of the fixing bolt head part (534a), is greatly increased, the upper and lower device cases (550) of the device structure (540) are fastened and fixed, and by bringing the cover part (556) of the upper device case (550) into close contact with the protection cover bottom surface portion (535), it is possible to minimize the gap between the upper and lower device cases (550) against the strong vertical vibration.

6) According to the present disclosure, the polymer smart manhole cover is made of a polymer material. Any manhole cover may belong to the same invention, regardless of the shape or structure of the manhole cover, as long as the manhole cover is made of a polymer material and employs the “direct transmission method” along with the characteristics mentioned above. This is because the shape and structure of the polymer smart manhole cover of the present disclosure is not limited to a specific shape and structure. For example, the characteristics of the present disclosure can also be applied to the structure of Korean Patent Registration No. 10-2299739, titled “Polymer circular manhole assembly with cover dislodgement prevention against backflow” (see FIGS. 11 and 12).

### Effects of Invention

(a) The present disclosure provides the advantage of manufacturing a polymer smart manhole cover employing a “direct transmission method”, in which, unlike the related indirect transmission method that transmits the radio wave via the transmitting antenna assembled in the radio wave through-hole of the cast iron manhole cover, the polymer smart manhole cover allows radio waves to pass through, thus eliminating a need for the radio wave through-hole of the transmitting antenna as a communication medium connecting inside and outside the manhole, and also eliminating a need for the assembly structure of the transmitting antenna assembled in the radio wave through-hole.

(b) The present disclosure provides the advantage of manufacturing a polymer smart manhole cover that transmits radio waves in which, unlike the related indirect transmission method, the structure employing the direct transmission method does not suffer the problem of the indirect transmission method where the exposed antenna is dislodged or gaps are formed in the assembly due to vibration and impact resulting from the rotating wheel friction force and the vehicle speed impact load of a large vehicle, thereby preventing ingress of rainwater into the device protection cover structure and avoiding the problem of malfunction of the device structure housed therein, thereby improving the performance and durability of the device structure.

(c) The manhole cover is not only subjected to the repeated rotating wheel friction force and vehicle speed impact load of the large vehicle, but also serves as a location where the manhole cover and the device protection cover structure are coupled to each other, and in consideration of the above, the present disclosure provides the advantage of adopting a fusion method to couple the two members rather than using the traditional bolt assembly method, and also generates a maximum fusion force (M) by maximizing a fusion area between the two members, such that the vertical vibration resulting from the rotating wheel friction force and the vehicle speed impact load of the passing vehicle over the manhole cover is fully resisted by the maximum welding force (M), and at the same time, upper and lower device cases (550) of a device structure (540) installed in the space (S) are firmly fastened and fixed by a fixing bolt body part (534a), which is an extension of a fixing bolt head part (534a) disposed between the two members fused and prevented from separating and dislodging, and a cover part (556) of the upper device case (550) is brought into close contact with a protection cover bottom surface portion (535), thereby minimizing a gap between the upper and lower device cases (550) against a strong vertical vibration of the manhole cover, a protection cover bottom plate (537), which is assembled with an ultrasonic water level sensor (548), is assembled to a cylindrical vertical support portion (536) by a connecting bolt (536b), thereby facilitating repair and battery replacement of the device structure (540), the maximum fusion force (M) is generated by the maximum fusion area of the protection cover fusion surface (532), and an anchor force (C) is generated by fusion inclination angles (α) of an inclined edge fastening groove (514) and a corresponding inclined fastening part (532a) for insertion into the inclined edge fastening groove (514), in which the two forces (M and C) are generated simultaneously such that a combined resultant force (T) of the two forces (M and C) provides a maximum resistance support force against the rotating wheel friction force and the vehicle speed impact load of the large vehicle, and in a state stabilized by the maximum resistance support force, measurements are obtained by using the ultrasonic water level sensor (548) and a gas sensor device (546) of the device structure (540) such that high-reliability measurement values are obtained and transmitted from a main device (544) through the polymer manhole cover to a central control room on the ground.

(d) The present disclosure provides the advantage in that a plurality of condensation water drainage holes and odor detection inlets (5374c) with clustered holes of 0.5 to 1 mm in diameter are formed on the horizontal part (5374), which is the lowermost surface portion of the device protection cover structure (530), so that these serve as an outlet for condensation generated due to the temperature difference between the inside and outside of the space (S), and also these serve as an inflow path for the odor of toxic gas generated at the bottom of the manhole to the gas sensor device (546).

### BRIEF DESCRIPTION OF THE DRAWINGS

FIG. 1 is a cross-sectional view of the ICT-based manhole cover assembly of Related Art 1 in its installed state.

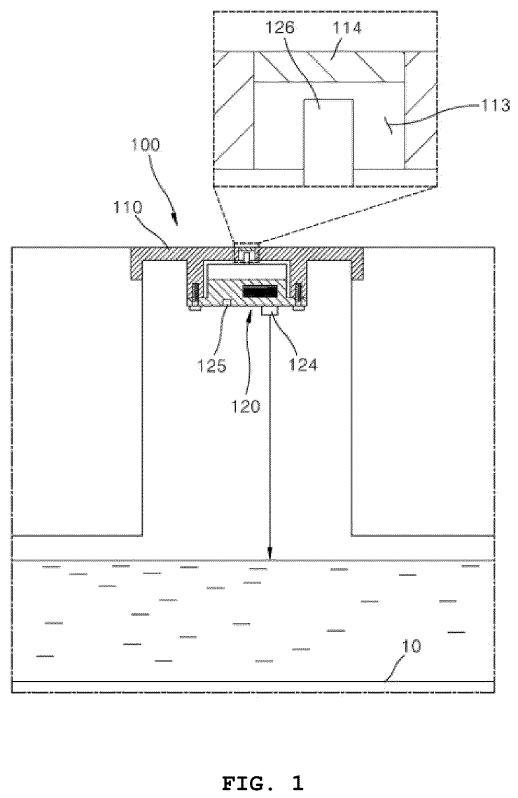

FIG. 2 is a rear view of the manhole cover of the ICT-based manhole cover assembly of Related Art 1.

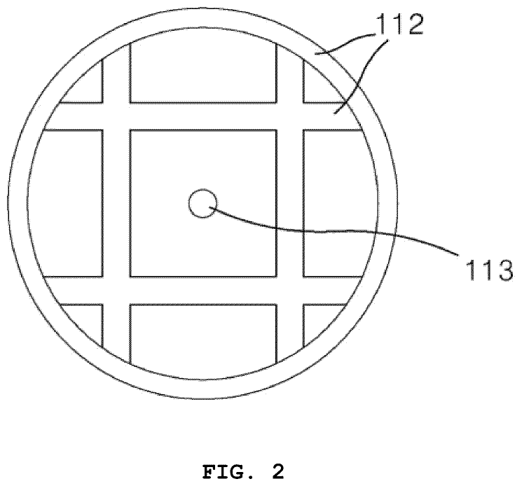

FIG. 3 is a side view of the manhole cover of the ICT-based manhole cover assembly of Related Art 1.

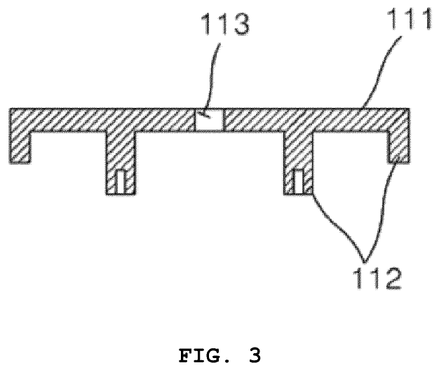

FIG. 4 is a block diagram illustrating the control relationship of the main components of a sewage management system of Related Art 1.

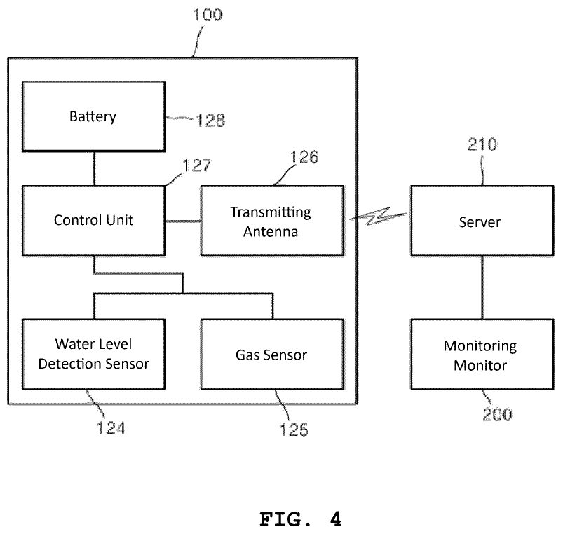

FIG. 5 is an exploded perspective view of a waterproof and embedded structure of an antenna module of the manhole cover of Related Art 2.

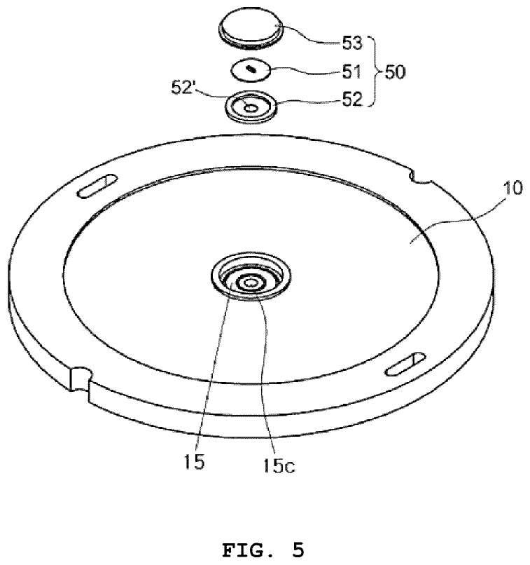

FIG. 6 is a cross-sectional view of a configuration of the manhole cover of Related Art 2.

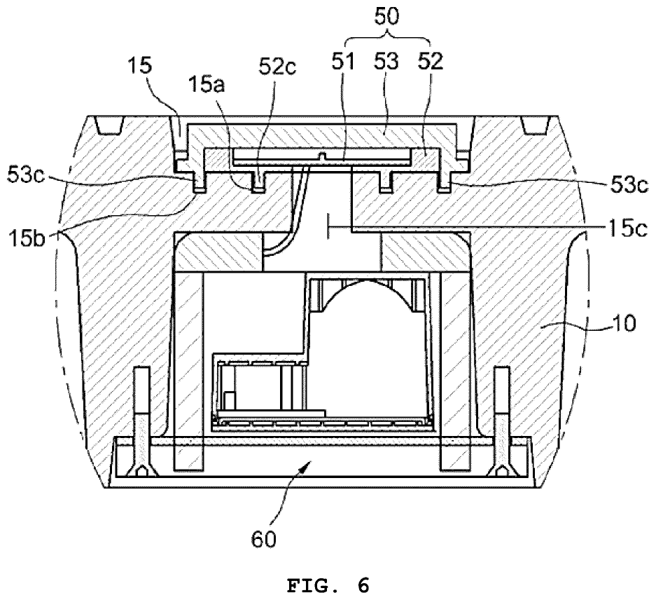

FIG. 7 is a cross-sectional perspective view of a device protection cover structure-fused polymer smart manhole cover employing direct transmission method according to the present disclosure.

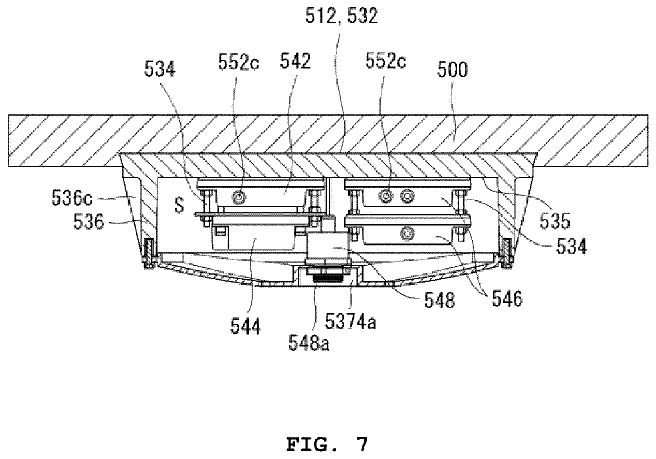

FIG. 8 is an exploded perspective view of FIG. 7.

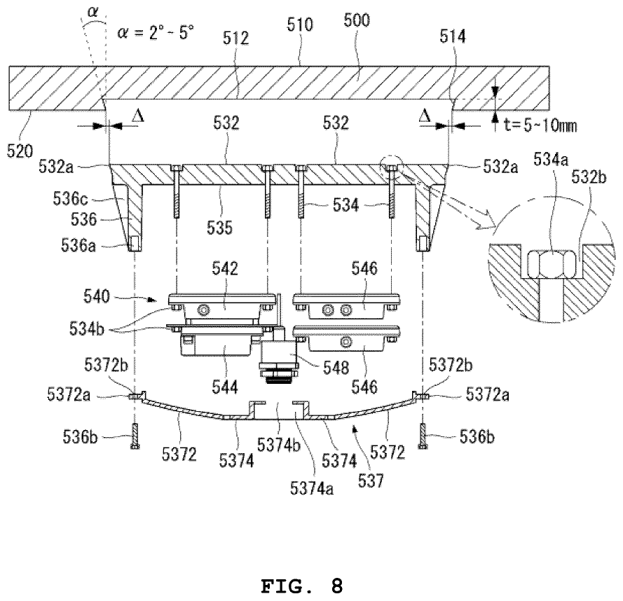

FIG. 9 is a diagram illustrating the arrangement of an ultrasonic water level sensor and a device structure (540) installed into a device protection cover structure, as well as the shape and configuration of the device case.

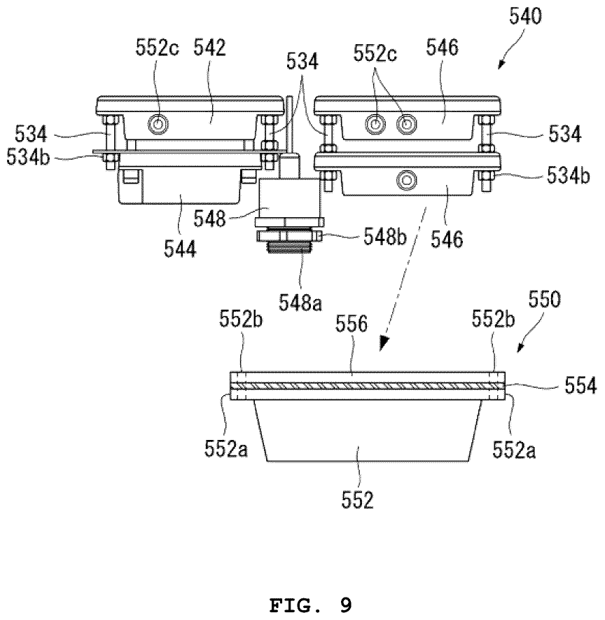

FIG. 10 is an exploded perspective view illustrating a manhole cover fusion surface (512), a protection cover fusion surface (532), and a protection cover bottom plate according to the present disclosure.

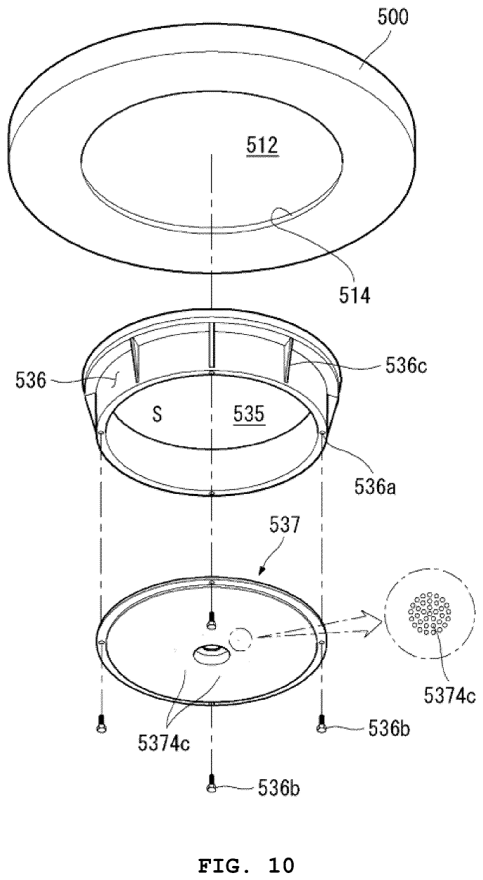

FIGS. 11 and 12 are views illustrating an example to which the technical content of the present disclosure is applicable.

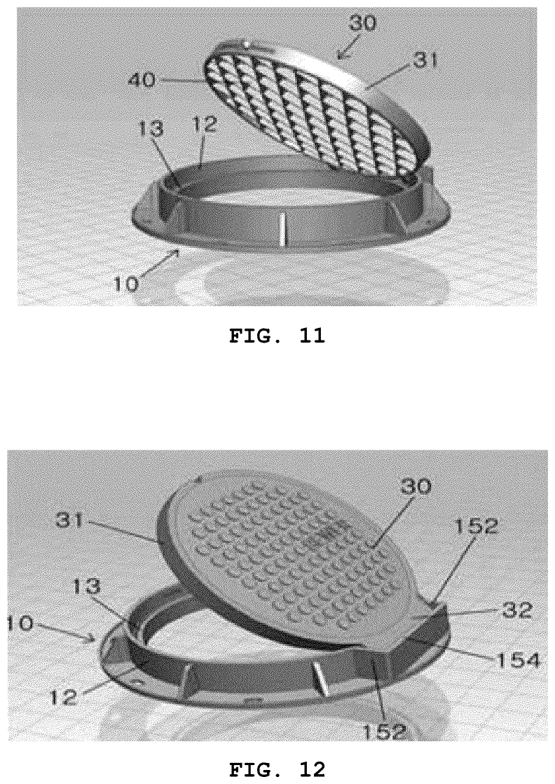

### BEST MODE FOR EMBODYING INVENTION

According to the present disclosure, a device protection cover structure-fused polymer smart manhole cover employing a direct transmission method is characterized in that: the manhole cover employing the direct transmission method includes a polymer composite material that transmits radio waves; a device protection cover structure (530) is integrally fused with a manhole cover bottom surface portion (520) by pressure-fusing a protection cover fusion surface (532) of the device protection cover structure (530) to a manhole cover fusion surface (512) of the manhole cover bottom surface portion (520); the polymer manhole cover is the manhole cover fusion surface (512) that is freshly molded and in a molten state at 200 to 230 °C, and the corresponding device protection cover structure (530) fused with the polymer manhole cover is the protection cover fusion surface (532), which is already cured and at room temperature; an inclined edge fastening groove (514) of the manhole cover bottom surface portion (520) has a fusion depth t=5 to 10 mm and a fusion inclination angle α=2 to 5°, and a corresponding inclined fastening part (532a) of the protection cover fusion surface (532) for insertion into the inclined edge fastening groove (514) has the same fusion depth and fusion inclination angle as those of the inclined edge fastening groove (514); an insertion tolerance between the inclined edge fastening groove (514) and the inclined fastening part (532a) is Δ=1.0 to 2.5 mm; a fixing bolt head part (534a) disposed between the manhole cover fusion surface (512) and the protection cover fusion surface (532) is fusion-fixed; in a space (S) defined by a cylindrical vertical support portion (536) extending vertically from the protection cover fusion surface (532) and by the protection cover fusion surface (532), a device case (550) of a device structure, which is of a quadrangular box shape (552), is fixed by a fixing bolt body part (534) that is an extension of the fixing bolt head part (534a) disposed between the protection cover fusion surface (532) and the manhole cover fusion surface (512), and an ultrasonic water level sensor (548) is assembled and fixed to a protection cover bottom plate (537) with a helical fastening part (548a) thereof.

### MODE FOR THE INVENTION

The configuration of a smart monitoring management system that uses the device protection cover structure-fused polymer smart manhole cover employing a direct transmission method according to the present disclosure is described below.

The smart monitoring management system that uses the device protection cover structure-fused polymer smart manhole cover employing the direct transmission method is characterized in that: the manhole cover employing the direct transmission method is a polymer composite material that transmits radio waves; a maximum fusion force (M) is generated by maximizing a fusion area formed between the manhole cover fusion surface (512) of the manhole cover bottom surface portion (520) and the protection cover fusion surface (532) by a “melting method”, so that a vertical vibration resulting from a rotating wheel friction force and a vehicle speed impact load of a vehicle passing over the manhole cover are fully resisted by the maximum fusion force (M); upper and lower device cases (550) of the device structure (540), which are installed in the space (S), are fastened and fixed by the fixing bolt body part (534) which is an extension of the fixing bolt head part (534a) disposed between two fused members prevented from separation and dislodgement; a cover part (556) of the upper device case (550) is brought into close contact with the protection cover bottom surface portion (535), thereby minimizing a gap between the upper and lower device cases (550) against a strong vertical vibration of the manhole cover; the protection cover bottom plate (537), which is assembled with the ultrasonic water level sensor (548), is assembled to the cylindrical vertical support portion (536) by a connecting bolt (536b), thereby facilitating repair and battery replacement of the device structure (540); the maximum fusion force (M) is generated by the maximum fusion area between the manhole cover fusion surface (512) and the protection cover fusion surface (532), and an anchor force (C) is generated by the fusion inclination angles (α) of the inclined edge fastening groove (514) and the corresponding inclined fastening part (532a) for insertion into the inclined edge fastening groove (514), in which the two forces (M and C) are generated simultaneously such that a combined resultant force (T) of the two forces (M and C) provides a maximum resistance support force against the rotating wheel friction force and the vehicle speed impact load of a large vehicle; and in a state stabilized by this maximum resistance support force, measurements are obtained by using the ultrasonic water level sensor (548) and a gas sensor device (546) of the device structure (540) such that high-reliability measurement values are obtained and transmitted from a main device (544) through the polymer manhole cover to the central control room on the ground.

Moreover, the smart monitoring management system that uses the device protection cover structure-fused polymer smart manhole cover employing the direct transmission method is characterized in that: the manhole cover fusion surface (512) of the manhole cover bottom surface portion (520) and the protection cover fusion surface (532) are pressure-fused; the polymer manhole cover is a freshly molded manhole cover fusion surface (512), which is in a molten state and at 200 to 230 °C, and the corresponding device protection cover structure (530) fused with the manhole cover fusion surface (512) is the cured protection cover fusion surface (532), which is already cured and at room temperature; the inclined edge fastening groove (514) of the manhole cover bottom surface portion (520) has the fusion depth t=5 to 10 mm and the fusion inclination angle α=2 to 5°, and the corresponding inclined fastening part (532a) of the protection cover fusion surface (532) for insertion into the inclined edge fastening groove (514), has the same fusion depth and fusion inclination angle as those of the inclined edge fastening groove (514); the insertion tolerance between the inclined edge fastening groove (514) and the inclined fastening part (532a) is Δ=1.0 to 2.5 mm; and the fixing bolt head part (534a) disposed between the manhole cover fusion surface (512) and the protection cover fusion surface (532) is fusion-fixed.

In addition, the smart monitoring management system that uses the device protection cover structure-fused polymer smart manhole cover employing the direct transmission method is characterized in that: in a state in which a main device case, an ultrasonic water level sensor device case, a gas sensor device case, and a 2-battery pack case of the device structure installed in the space (S) of the device protection cover structure (530) are arranged symmetrically on both sides as well as on upper and lower sides, the upper and lower device cases (550), which are arranged symmetrically on both sides as well as on upper and lower sides, are fastened and fixed with the fixing bolt body parts (534) between the maximum fusion force (M) generated as described above; and the cover part (556) of the upper device case (550) is brought into close contact with and fixed to the protection cover bottom surface portion (535), thereby preventing the formation of a gap caused by the impact vibration resulting from the rotating wheel friction force and the vehicle speed impact load of a large vehicle passing over the polymer smart manhole cover (500). In addition, the smart monitoring management system that uses the device protection cover structure-fused polymer smart manhole cover employing the direct transmission method is characterized in that: a plurality of condensation water drainage holes and odor detection inlets (5374c), which include clustered holes of 0.5 to 1.5 mm in diameter, are formed at multiple locations on a horizontal part (5374) which is the lowermost surface of the device protection cover structure (530).

The gas sensor device (546) and the ultrasonic water level sensor (548) of the device structure (540) will be described below.

The gas sensor device (546) is a toxic gas odor detection sensor inside the manhole.

The toxic gas odor introduced through the condensation water drainage holes and the odor detection inlet (5374c) formed in the protection cover bottom plate (537) is detected by the gas sensor device (546).

The ultrasonic water level sensor (548) is a non-contact measurement method that emits ultrasonic waves on the water surface at the bottom of the manhole and detects the water level. The non-contact measurement method is a method that does not require any intermediate installation structure. The ultrasonic wave is emitted through a passage (not shown) in the center of the helical fastening part (548a) of the ultrasonic water level sensor (548).

As such, since the smart monitoring management system that uses the device protection cover structure-fused polymer smart manhole cover employing the direct transmission method is a non-exposure transmission type that employs the “direct transmission method”, the problem such as malfunction of the device structure due to rainwater penetration does not occur.

In addition, according to an advantageous aspect of the present disclosure, the manhole cover includes a polymer composite material that transmits radio waves and employs the direct transmission method unlike the related cast manhole that employs the indirect transmission method; the water level and the toxic gas are measured by using the device structure installed into the device protection cover structure (530), and fusing the device protection cover structure (530) to the manhole cover bottom surface portion (520) involves fusing the manhole cover fusion surface (512) and the protection cover fusion surface (532) to each other, in which \textcircled{1} the maximum fusion force (M) is generated by maximizing the fusion area between the two surfaces, \textcircled{2} the anchor force (A) is generated by the fusion inclination angle (α) of the inclined fastening part (531a) for insertion into the inclined edge fastening groove (514), and \textcircled{3} the combined resultant force (T) of the maximum fusion force (M) and the anchor force (A) of the fusion inclination angle (α) corresponds to the maximum resistance support force against the rotating wheel friction force and the vehicle speed impact load of the large passing vehicle.

### INDUSTRIAL APPLICABILITY

In addition, according to an advantageous aspect of the present disclosure, the manhole cover includes a polymer composite material that transmits radio waves and employs the direct transmission method unlike the related cast manhole that employs the indirect transmission method; the water level and the toxic gas are measured by using the device structure installed into the device protection cover structure (530); and fusing the device protection cover structure (530) to the manhole cover bottom surface portion (520) involves fusing the manhole cover fusion surface (512) and the protection cover fusion surface (532) to each other, in which \textcircled{1} the maximum fusion force (M) is generated by maximizing the fusion area between the two surfaces, \textcircled{2} the anchor force (A) is generated by the fusion inclination angle (α) of the inclined fastening part (531a) for insertion into the inclined edge fastening groove (514), and \textcircled{3} the combined resultant force (T) of the maximum fusion force (M) and the anchor force (A) of the fusion inclination angle (α) corresponds to the maximum resistance support force against the rotating wheel friction force and the vehicle speed impact load of the large passing vehicle.

1. A device protection cover structure-fused polymer smart manhole cover employing a direct transmission method, wherein:
the manhole cover employing the direct transmission method includes a polymer composite material that transmits radio waves;
an integrally fusing the device protection cover structure (530) to a polymer smart manhole cover (500) involves pressure-fusing a protection cover fusion surface (532) of the device protection cover structure (530) to a manhole cover fusion surface (512) of a manhole cover bottom surface portion (520);
a polymer manhole cover is the manhole cover fusion surface (512) that is freshly molded and in a molten state at 200 to 230 °C, and the corresponding device protection cover structure (530) fused with the manhole cover fusion surface (512) is the protection cover fusion surface (532) that is already cured and at room temperature;
the manhole cover bottom surface portion (520) includes an inclined edge fastening groove (514) having a fusion depth t=5 to 10 mm and a fusion inclination angle α=2 to 5°, and the protection cover fusion surface (532) includes a corresponding inclined fastening part (532a) for insertion into the inclined edge fastening groove (514), which has the same fusion depth and fusion inclination angle as those of the inclined edge fastening groove (514);
an insertion tolerance between the inclined edge fastening groove (514) and the inclined fastening part (532a) is Δ=1.0 to 2.5 mm;
a fixing bolt head part (534a) is disposed between the manhole cover fusion surface (512) and the protection cover fusion surface (532) and fusion-fixed;
in a space (S) defined by a cylindrical vertical support portion (536) extending vertically from the protection cover fusion surface (532) and by the protection cover fusion surface (532), a device case (550) of a device structure, which is of a quadrangular box shape (552), is fixed by a fixing bolt body part (534) that is an extension of the fixing bolt head part (534a) disposed between the protection cover fusion surface (532) and the manhole cover fusion surface (512); and
an ultrasonic water level sensor (548) is assembled and fixed to a protection cover bottom plate (537) with a helical fastening part (548a) thereof.

2. The device protection cover structure-fused polymer smart manhole cover according to claim 1, wherein a maximum fusion force (M) is generated by a maximum fusion area between the manhole cover fusion surface (512) and the protection cover fusion surface (532), and an anchor force (C) is generated by a fusion inclination angles (α) of the inclined edge fastening groove (514) and the corresponding inclined fastening part (532a) for insertion into the inclined edge fastening groove (514), wherein the forces (M and C) are generated simultaneously to provide a maximum resistance support force against a “rotating wheel friction force” and a “vehicle speed impact load” of a large vehicle.

3. The device protection cover structure-fused polymer smart manhole cover according to claim 1, wherein fixing the device structure (540) involves fixing device cases (550), which are of the same size and are arranged symmetrically on upper and lower sides as well as on both sides, within the space (S) by the fixing bolt body part (534) that is the extension of the fixing bolt head part (534a) disposed between the protection cover fusion surface (532) and the manhole cover fusion surface (512), and bringing a cover part (556) of the upper device case

(550) into close contact with a protection cover bottom surface portion (535), thereby preventing the formation of a gap due to an impact vibration resulting from a “rotating wheel friction force” and a “vehicle speed impact load” of a large vehicle passing over the polymer smart manhole cover (500).

4. The device protection cover structure-fused polymer smart manhole cover according to claim 1, wherein the device case (550), which is of the quadrangular box-shape (552) and is fixed and supported by the fixing bolt body part (534) that is the extension of the fixing bolt head part (534a) disposed between the protection cover fusion surface (532) and the manhole cover fusion surface (512), includes cases for a main device (542), a gas sensor device (544), and a battery pack (546) of the device structure (540), and the ultrasonic water level sensor of the device structure (540) assembled to a fastening part (5374a) of the protection cover bottom plate (537) is fixed by a fixing nut (548b).

5. The device protection cover structure-fused polymer smart manhole cover according to claim 1, wherein a plurality of condensation water drainage holes and odor detection inlets (5374c), which include clustered holes of 0.5 to 1 mm in diameter, are formed at multiple locations on a horizontal part (5374), which is a lowermost surface portion of the device protection cover structure (530).

6. A smart monitoring management system that uses a device protection cover structure-fused polymer smart manhole cover employing a direct transmission method, wherein:
the manhole cover employing the direct transmission method includes a polymer composite material that transmits radio waves;
a maximum fusion force (M) is generated by maximizing a fusion area formed by a “melting method” between a manhole cover fusion surface (512) of a manhole cover bottom surface portion (520) and a protection cover fusion surface (532) so that a vertical vibration resulting from a “rotating wheel friction force” and a “vehicle speed impact load” of a vehicle passing over the manhole cover are fully resisted by the maximum fusion force (M);
upper and lower device cases (550) of a device structure (540), which are installed in a space (S), are fastened and fixed by a fixing bolt body part (534) that is an extension of a fixing bolt head part (534a) disposed between two members fused and prevented from separation and dislodgement;
a cover part (556) of the upper device case (550) is brought into close contact with a protection cover bottom surface portion (535), thereby minimizing a gap between the upper and lower device cases (550) against a strong vertical vibration of the manhole cover;
a protection cover bottom plate (537), which is assembled with an ultrasonic water level sensor (548), is assembled to a cylindrical vertical support portion (536) by a connecting bolt (536b), thereby facilitating repair and battery replacement of the device structure (540);
the maximum fusion force (M) is generated by the maximum fusion area between the manhole cover fusion surface (512) and the protection cover fusion surface (532), and an anchor force (C) is generated by fusion inclination angles (α) of an inclined edge fastening groove (514) and a corresponding inclined fastening part (532a) for insertion into the inclined edge fastening groove (514), wherein the two forces (M and C) are generated simultaneously such that a combined resultant force (T) of the two forces (M and C) provides a maximum resistance support force against the “rotating wheel friction force” and the “vehicle speed impact load” of the large vehicle; and
in a state stabilized by the maximum resistance support force, measurements are obtained by using the ultrasonic water level sensor (548) and a gas sensor device (546) of the device structure (540) such that high-reliability measurement values are obtained and transmitted from a main device (544) through the polymer manhole cover to a central control room on the ground.

7. The device protection cover structure-fused polymer smart manhole cover according to claim 6, wherein:
the manhole cover fusion surface (512) of the manhole cover bottom surface portion (520) and the protection cover fusion surface (532) are pressure-fused;
the polymer manhole cover is the manhole cover fusion surface (512) that is freshly molded and in a molten state at 200 to 230 °C, and the corresponding device protection cover structure (530) fused with the manhole cover fusion surface (512) is the protection cover fusion surface (532) that is already cured and at room temperature;
the manhole cover bottom surface portion (520) includes the inclined edge fastening groove (514) having a fusion depth t=5 to 10 mm and a fusion inclination angle α=2 to 5°, and the protection cover fusion surface (532) includes the corresponding inclined fastening part (532a) for insertion into the inclined edge fastening groove (514), which has the same fusion depth and fusion inclination angle as those of the inclined edge fastening groove (514); and
an insertion tolerance between the inclined edge fastening groove (514) and the inclined fastening part (532a) is Δ=1.0 to 2.5 mm; and
the fixing bolt head part (534a), which is disposed between the manhole cover fusion surface (512) and the protection cover fusion surface (532), is fusion-fixed.

8. The device protection cover structure-fused polymer smart manhole cover according to claim 6, wherein, in a state in which a main device case, an ultrasonic water level sensor device case, a gas sensor device case, and a 2-battery pack case of the device structure are installed in the space (S) of the device protection cover structure (530) and arranged symmetrically on both sides as well as on upper and lower sides, the upper and lower device cases (550), which are arranged symmetrically on both sides as well as on upper and lower sides, are fastened and fixed by the fixing bolt body part (534) between the generated maximum fusion forces (M), and a cover part (556) of the upper device case (550) is brought into close contact with the protection cover bottom surface portion (535), thereby preventing the formation of a gap due to an impact vibration resulting from the “rotating wheel friction force” and the “vehicle speed impact load” of the large vehicle passing over the polymer smart manhole cover (500).

9. The device protection cover structure-fused polymer smart manhole cover according to claim 6, wherein a plurality of condensation water drainage holes and odor detection inlets (5374c), which include clustered holes of 0.5 to 1.5 mm in diameter, are formed at multiple locations on a horizontal part (5374), which is a lowermost surface of the device protection cover structure (530).
